(19) United States
(12) Patent Application Publication
(10) Pub. No.: US 2024/0099548 A1
(43) Pub. Date: Mar. 28, 2024

(54) APPLIANCE CONTROL PANEL WITH IMPROVED STATUS INDICATOR ILLUMINATION

(71) Applicant: Haier US Appliance Solutions, Inc., Wilmington, DE (US)

(72) Inventors: Michelle Diana Gross Berry, Louisville, KY (US); Kyle James Brewer, Louisville, KY (US); Brian J. Morman, Louisville, KY (US); Timothy David Kaiser, Louisville, KY (US)

(21) Appl. No.: 17/952,542

(22) Filed: Sep. 26, 2022

(51) Int. Cl. A47L 15/42; F21V 3/00; F21V 7/00

(52) U.S. Cl. CPC A47L 15/4293; F21V 3/00; F21V 7/0008

(57) ABSTRACT

A dishwasher appliance is provided. The dishwasher appliance may include a cabinet, a door pivotably mounted to the cabinet, and a control panel located on a panel of the door. The control panel may include a printed circuit board, a light source, and a control cover. The printed circuit board may define a top surface and a bottom surface. The light source may be mounted to the bottom surface of the printed circuit board for selectively generating light. The control cover may be mounted to the top surface and may extend parallel to the top surface. The control cover may define a light channel. The control cover may include a reflective surface extending towards the light source from the control surface. The reflective surface may be angled to direct light selectively generated from the light source towards the light channel.

### FIELD OF THE INVENTION

The present subject matter relates generally to control panels for appliances, and more particularly to door-mounted control panels including features for improved light placement for illuminating status indicators.

### BACKGROUND OF THE INVENTION

Appliances frequently include doors for closing, insulating, concealing, or otherwise providing selective access to cavities or chambers of the appliance. These doors typically include an inner and outer door that are separated by an air gap which may be filled with fiberglass or insulating foam, e.g., for thermal insulation, sound dampening, etc. In order to provide a user with information regarding the appliance operation, e.g., such as a status of an operating cycle or an indication that a cycle is complete, status indicators are often positioned on the outer door of the appliance such that they are visible to a user of the appliance. In addition, or alternatively, appliances such as dishwasher appliance may include control panels that are integrated into the top of the dishwasher door, e.g., to minimize features on the outer door and provide a clean look.

Notably, however, dishwasher doors have limited space within which the desired electronics associated with user interface or control panels may be mounted. For example, certain conventional control panels include a printed circuit board that is positioned directly below the top surface of the control panel and light sources that are mounted on top of the printed circuit board below illumination zones to light up those zones. However, printed circuit boards are limited in that circuit printing generally cannot occur along the edges of the printed circuit boards, which may limit the placement of light sources mounted on the printed circuit boards. In some appliances, such as those with compact designs, this limited placement may result in non-uniform illumination or difficulty for a user viewing whether status indicators on the control panel are illuminated.

Accordingly, an appliance having an improved lighting assembly on a door would be beneficial. Additionally, a control panel for an appliance with a compact design that allowed for improved illumination of status indicators would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a control panel is provided. The control panel may include a printed circuit board, a light source, a control cover, and a reflective surface. The printed circuit board may define a top surface and a bottom surface. The top surface may be located on an opposing surface from the bottom surface. The light source may be mounted to the bottom surface of the printed circuit board for selectively generating light. The control cover may be mounted to the top surface of the printed circuit board. The control cover may define a light channel. The reflective surface may extend towards the light source from the control cover. The reflective surface may be angled to direct light selectively generated from the light source towards the light channel.

In another exemplary aspect of the present disclosure, a dishwasher appliance is provided. The dishwasher appliance may define a lateral direction, a vertical direction, and a transverse direction. The dishwasher appliance may include a cabinet, a door pivotably mounted to the cabinet and having a closed position, and a control panel. The control panel may be located on a panel of the door. The control panel may define an illumination direction. The control panel may include a printed circuit board, a light source, and a control cover. The printed circuit board may define a top surface and a bottom surface. The top surface may be located on an opposing surface from the bottom surface. The light source may be mounted to the bottom surface of the printed circuit board for selectively generating light. The control cover may be mounted to the top surface of the printed circuit board. The control cover may extend parallel to the top surface of the printed circuit board. The control cover may define a light channel. The control cover may include a reflective surface extending towards the light source from the control surface. The reflective surface may be angled to direct light selectively generated from the light source towards the light channel.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a dishwasher appliance, including a dishwasher door according to exemplary embodiments of the present disclosure.

FIG. 2 provides a cross-sectional side view of the exemplary dishwashing appliance of FIG. 1.

FIG. 3 provides a close-up perspective view of a control panel of the exemplary dishwasher door of FIG. 1 according to exemplary embodiments of the present disclosure.

FIG. 4 provides a cross-sectional perspective view of the exemplary control panel of FIG. 3 according to exemplary embodiments of the present disclosure.

FIG. 5 provides a cross-sectional side view of the exemplary control panel of FIG. 3 taken along line 5-5 of FIG. 3 according to exemplary embodiments of the present disclosure.

Use of the same or similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. In addition, the term “or” is generally intended to be inclusive (i.e., “A or B” is intended to mean “A or B or both”). Furthermore, as used herein, terms of approximation, such as “approximately,” “substantially,” or “about,” refer to being within a ten percent margin of error.

The present disclosure advantageously provides a control panel for an appliance that may provide improved lighting sources for buttons on the control panel. The control panel may include a printed circuit board and a light source mounted to a bottom of the printed circuit board. A reflective surface may be attached to a control cover of the control panel. The reflective surface may direct light from the light source towards a light channel of the control panel. Advantageously, embodiments described herein may reduce part counts in appliances, reduce assembly operation steps, reduce the number of light sources needed, or improve cost benefits. Light positioning on control panels as described herein may allow light to be projected beyond the printed circuit board, thus improving flexibility in graphics or button placement for the control panel. For example, embodiments described herein may allow more directions for light to be projected to without the use of light pipes, guides, or etc., or additional light sources indirectly connected to a control board. The use of light sources located below the circuit board may further reduce assembly operation steps, as circuit board may be attached directly to a control cover.

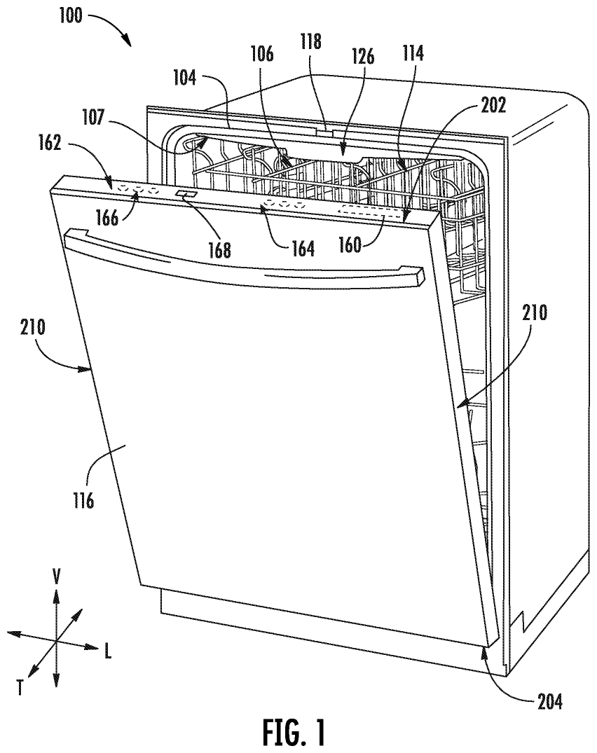

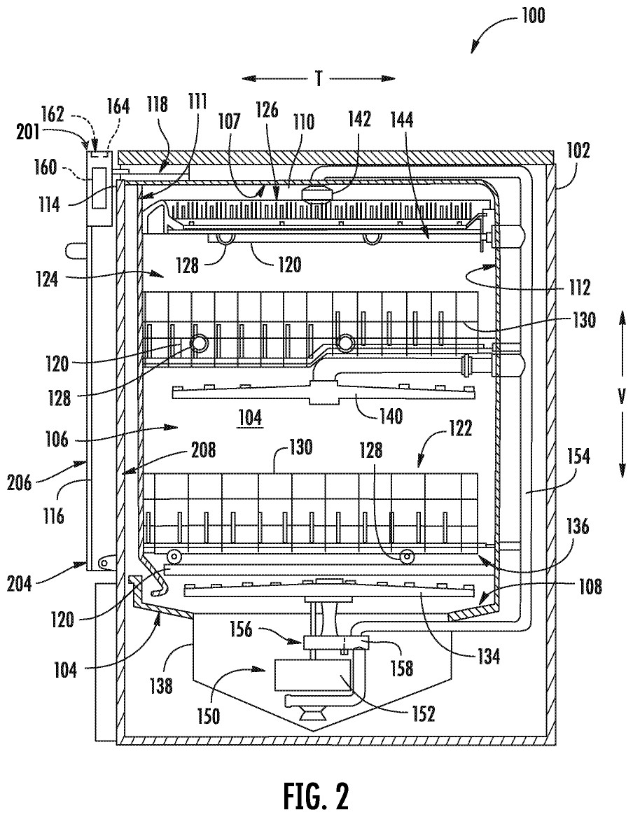

FIGS. 1 and 2 depict an exemplary domestic dishwasher or dishwashing appliance 100 that may be configured in accordance with aspects of the present disclosure. For the particular embodiment of FIGS. 1 and 2, the dishwasher 100 includes a cabinet 102 having a tub 104 therein that defines a wash chamber 106. As shown, tub 104 extends between a top 107 and a bottom 108 along a vertical direction V, between a pair of side walls 110 along a lateral direction L, and between a front side 111 and a rear side 112 along a transverse direction T. Each of the vertical direction V, lateral direction L, and transverse direction T are mutually orthogonal to one another.

The tub 104 includes a front opening 114 and a door 116 hinged at its bottom for movement between a normally closed vertical position (shown in FIG. 2), wherein the wash chamber 106 is sealed shut for washing operation, and a horizontal open position for loading and unloading of articles from the dishwasher 100. According to exemplary embodiments, dishwasher 100 further includes a door closure mechanism or assembly 118 that is used to lock and unlock door 116 for accessing and sealing wash chamber 106.

As illustrated in FIG. 2, tub side walls 110 may accommodate a plurality of rack assemblies. More specifically, guide rails 120 may be mounted to side walls 110 for supporting a lower rack assembly 122, a middle rack assembly 124, and an upper rack assembly 126. As illustrated, upper rack assembly 126 is positioned at a top portion of wash chamber 106 above middle rack assembly 124, which is positioned above lower rack assembly 122 along the vertical direction V. Each rack assembly 122, 124, 126 is adapted for movement between an extended loading position (not shown) in which the rack is substantially positioned outside the wash chamber 106, and a retracted position (shown in FIGS. 1 and 2) in which the rack is located inside the wash chamber 106. This is facilitated, for example, by rollers 128 mounted onto rack assemblies 122, 124, 126, respectively. Although guide rails 120 and rollers 128 are illustrated herein as facilitating movement of the respective rack assemblies 122, 124, 126, it should be appreciated that any suitable sliding mechanism or member may be used according to alternative embodiments.

Some or all of the rack assemblies 122, 124, 126 are fabricated into lattice structures including a plurality of wires or elongated members 130 (for clarity of illustration, not all elongated members making up rack assemblies 122, 124, 126 are shown in FIG. 2). In this regard, rack assemblies 122, 124, 126 are generally configured for supporting articles within wash chamber 106 while allowing a flow of wash fluid to reach and impinge on those articles (e.g., during a cleaning or rinsing cycle). According to another exemplary embodiment, a silverware basket (not shown) may be removably attached to a rack assembly (e.g., lower rack assembly 122) for placement of silverware, utensils, and the like, which are otherwise too small to be accommodated by rack 122.

Dishwasher 100 further includes a plurality of spray assemblies for urging a flow of water or wash fluid onto the articles placed within wash chamber 106. More specifically, as illustrated in FIG. 2, dishwasher 100 includes a lower spray arm assembly 134 disposed in a lower region 136 of wash chamber 106 and above a sump 138 so as to rotate in relatively close proximity to lower rack assembly 122. Similarly, a mid-level spray arm assembly 140 is located in an upper region of wash chamber 106 and may be located below and in close proximity to middle rack assembly 124. In this regard, mid-level spray arm assembly 140 may generally be configured for urging a flow of wash fluid up through middle rack assembly 124 and upper rack assembly 126. Additionally, an upper spray assembly 142 may be located above upper rack assembly 126 along the vertical direction V. In this manner, upper spray assembly 142 may be configured for urging or cascading a flow of wash fluid downward over rack assemblies 122, 124, and 126. As further illustrated in FIG. 2, upper rack assembly 126 may further define an integral spray manifold 144, which is generally configured for urging a flow of wash fluid substantially upward along the vertical direction V through upper rack assembly 126.

The various spray assemblies and manifolds described herein may be part of a fluid distribution system or fluid circulation assembly 150 for circulating water and wash fluid in tub 104. More specifically, fluid circulation assembly 150 includes a pump 152 for circulating water or wash fluid (e.g., detergent, water, or rinse aid) in tub 104. Pump 152 may be located within sump 138 or within a machinery compartment located below sump 138 of tub 104, as generally recognized in the art. Fluid circulation assembly 150 may include one or more fluid conduits or circulation piping for directing water or wash fluid from pump 152 to the various spray assemblies and manifolds. For example, as illustrated in FIG. 2, a primary supply conduit 154 may extend from pump 152, along rear 112 of tub 104 along the vertical direction V to supply wash fluid throughout wash chamber 106.

As illustrated, primary supply conduit 154 is used to supply wash fluid to one or more spray assemblies (e.g., to mid-level spray arm assembly 140 and upper spray assembly 142). However, it should be appreciated that according to alternative embodiments, any other suitable plumbing configuration may be used to supply wash fluid throughout the various spray manifolds and assemblies described herein. For example, according to another exemplary embodiment, primary supply conduit 154 could be used to provide wash fluid to mid-level spray arm assembly 140 and a dedicated secondary supply conduit (not shown) could be utilized to provide wash fluid to upper spray assembly 142. Other plumbing configurations may be used for providing wash fluid to the various spray devices and manifolds at any location within dishwasher appliance 100.

Each spray arm assembly 134, 140, 142, integral spray manifold 144, or other spray device may include an arrangement of discharge ports or orifices for directing wash fluid received from pump 152 onto dishes or other articles located in wash chamber 106. The arrangement of the discharge ports, also referred to as jets, apertures, or orifices, may provide a rotational force by virtue of wash fluid flowing through the discharge ports. Alternatively, spray arm assemblies 134, 140, 142 may be motor-driven, or may operate using any other suitable drive mechanism. Spray manifolds and assemblies may also be stationary. The resultant movement of the spray arm assemblies 134, 140, 142 and the spray from fixed manifolds provides coverage of dishes and other dishwasher contents with a washing spray. Other configurations of spray assemblies may be used as well. For example, dishwasher 100 may have additional spray assemblies for cleaning silverware, for scouring casserole dishes, for spraying pots and pans, for cleaning bottles, etc. One skilled in the art will appreciate that the embodiments discussed herein are used for the purpose of explanation only and are not limitations of the present subject matter.

In operation, pump 152 draws wash fluid in from sump 138 and pumps it to a diverter assembly 156 (e.g., which may be positioned within sump 138 of dishwasher appliance 100). Diverter assembly 156 may include a diverter disk (not shown) disposed within a diverter chamber 158 for selectively distributing the wash fluid to the spray arm assemblies 134, 140, 142 or other spray manifolds or devices. For example, the diverter disk may have a plurality of apertures that are configured to align with one or more outlet ports (not shown) at the top of diverter chamber 158. In this manner, the diverter disk may be selectively rotated to provide wash fluid to the desired spray device.

According to an exemplary embodiment, diverter assembly 156 is configured for selectively distributing the flow of wash fluid from pump 152 to various fluid supply conduits, only some of which are illustrated in FIG. 2 for clarity. More specifically, diverter assembly 156 may include four outlet ports (not shown) for supplying wash fluid to a first conduit for rotating lower spray arm assembly 134 in the clockwise direction, a second conduit for rotating lower spray arm assembly 134 in the counter-clockwise direction, a third conduit for spraying an auxiliary rack such as the silverware rack, and a fourth conduit for supply mid-level or upper spray assemblies 140, 142 (e.g., such as primary supply conduit 154).

The dishwasher 100 is further equipped with a controller 160 to regulate operation of the dishwasher 100. Controller 160 may include one or more memory devices and one or more microprocessors, such as general or special purpose microprocessors operable to execute programming instructions or micro-control code associated with a cleaning cycle. The memory may represent random access memory such as DRAM or read only memory such as ROM or FLASH. In one embodiment, the processor executes programming instructions stored in memory. The memory may be a separate component from the processor or may be included onboard within the processor. Alternatively, controller 160 may be constructed without using a microprocessor (e.g., using a combination of discrete analog or digital logic circuitry, such as switches, amplifiers, integrators, comparators, flip-flops, AND gates, and the like) to perform control functionality instead of relying upon software.

Controller 160 may be positioned in a variety of locations throughout dishwasher 100. In the illustrated embodiment, controller 160 may be located within a control panel area 162 of door 116, as shown in FIGS. 1 and 2. In such an embodiment, input/output (“I/O”) signals may be routed between the control system and various operational components of dishwasher 100 along wiring harnesses that may be routed through the bottom of door 116. Typically, the controller 160 includes a user interface panel 164 through which a user may select various operational features and modes and monitor progress of the dishwasher 100. In one embodiment, the user interface 164 may represent a general purpose I/O (“GPIO”) device or functional block. In certain embodiments, the user interface 164 includes input components 166, such as one or more of a variety of electrical, mechanical, or electro-mechanical input devices including rotary dials, push buttons, and touch pads. The user interface 164 may further include one or more display components 168, such as a digital display device or one or more indicator light assemblies designed to provide operational feedback to a user. The user interface 164 may be in communication with controller 160 via one or more signal lines or shared communication busses.

It should be appreciated that the invention is not limited to any particular style, model, or configuration of dishwasher 100. The exemplary embodiment depicted in FIGS. 1 and 2 is for illustrative purposes only. For example, different locations may be provided for user interface 164, different configurations may be provided for rack assemblies 122, 124, 126, different spray arm assemblies 134, 140, 142 and spray manifold configurations may be used, and other differences may be applied while remaining within the scope of the present subject matter. Moreover, aspects of the present subject matter may be applied to other appliances as well, such as refrigerators, ovens, microwaves, etc.

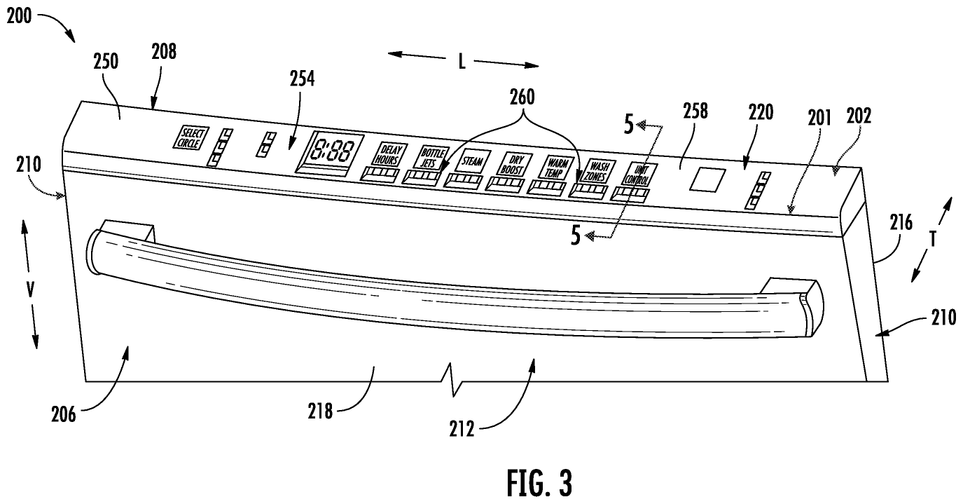

Referring now generally to FIGS. 3 through 5, a door assembly 200 will be described according to exemplary embodiments of the present subject matter. For example, door assembly 200 may be used as door 116 of dishwashing appliance 100. Alternatively, door assembly 200 may be used on any other suitable residential or commercial appliance. As described herein, door assembly 200 may share a coordinate system with dishwashing appliance 100, e.g., when door assembly 200 is in the closed position (e.g., as shown in FIG. 2). Specifically, door assembly 200 may define a vertical direction V, a lateral direction L, and a transverse direction T. Therefore, these directions may be used herein to refer to features of door assembly 200 and its various components and sub-assemblies. Referring briefly again to FIGS. 1 and 2, in the normally closed position, door assembly 200 (illustrated for example as door 116) extends from a top end or front edge 201 to a bottom end or bottom edge 204 along the vertical direction V; from a front end 206 to a rear end 208 along the transverse direction T; and between two lateral ends 210 along the lateral direction L.

As best illustrated in FIG. 3, door assembly 200 may include a door frame 212 that is formed from one or more exterior panels. In general, these exterior panels of door frame 212 define an interior chamber 214 of door assembly 200. For example, door assembly 200 generally includes an inner door panel 216 and an outer door panel or a front panel 218 which are spaced apart from each other along the transverse direction T to define a door gap or interior chamber 214 of door assembly 200 therebetween. For instance, outer door panel 218 may be positioned at or proximal to the front end 206 (i.e., distal to the rear end 208) and inner door panel 216 may be positioned at or proximal to the rear end 208 (i.e., distal to the front end 206). Door assembly 200 may further include a top panel 202. Front edge 201 may extend between top panel 202 and front panel 218.

According to exemplary embodiments, inner door panel 216 and outer door panel 218 may be panels that are stamped from stainless steel. Alternatively, inner door panel 216 and outer door panel 218 may be formed from any other suitably rigid material, such as thermoformed plastic, other metals, etc. In general, inner door panel 216 and outer door panel 218 may be assembled in any suitable manner. In addition, inner door panel 216 and outer door panel 218 may be secured together using any suitable mechanical fastener, welding, snap-fit mechanisms, etc. In addition, it should be appreciated that an insulating material (not shown), such as fiberglass or foam insulation, may be positioned within interior chamber 214 to provide thermal and/or sound insulation to dishwashing appliance 100.

As illustrated, door assembly 200 may generally include a control panel 220 that is mounted on door assembly 200 and is generally configured for facilitating user interaction with the dishwasher 100. In this regard, for example, control panel 220 (e.g., which may correspond to control panel 162 from FIG. 1) may be in direct operative communication with controller 160 of dishwasher 100, such that user inputs via control panel 220 may be directly used to regulate operation of various components of dishwasher 100.

According to the illustrated embodiment, control panel 220 may be positioned on top panel 202 of door assembly 200 along the vertical direction V. Thus, e.g., control panel 220 may be partially hidden below a countertop when dishwasher appliance 100 is installed below the countertop and door 116 (e.g., door assembly 200) is closed. Accordingly, dishwasher appliance 100 may be referred to as a “top control dishwasher appliance.” In this regard, control panel 220 may be adjacent to an outer panel (e.g., adjacent to front panel 218 in FIG. 3). However, it should be appreciated that aspects of the present subject matter may be used with dishwasher appliances having other configurations or any other suitable appliance. For example, control panel 220 may be mounted on a front end 206 of door assembly 200 or may be mounted directly to an appliance cabinet or other suitable support structure for regulating the operation of any suitable appliance.

Additionally or alternatively, control panel 220 may be mounted on front panel 218 of dishwasher appliance 100. In some embodiments, front panel 218 may include a cutout portion (not shown), forming a pocket handle. The cutout portion may define a pocket handle recess. The control panel 220 may be mounted on the cutout portion on the front panel 218. An illumination direction (which will be discussed in more detail below) may be located perpendicular to a length of the pocket handle recess where control panel 220 is located. In this manner, the illumination direction may be directed upwards at an angle between the vertical direction V and the transverse direction T when the door assembly 200 is in the closed position. Such may aid a user in viewing control panel 220 when proximate to the door assembly 200 in the closed position.

According to exemplary embodiments of the present subject matter, control panel 220 may generally define a display direction or illumination direction (e.g., identified generally by reference numeral 222). In general, illumination direction 222 may refer to the direction along which a user typically views control panel 220. For example, for a top control dishwasher appliance 100, the illumination direction 222 may generally extend normal to top panel 202 of door assembly 200. In other words, illumination direction 222 extends along the vertical direction V when door assembly 200 is in the closed position and along the transverse direction T when door assembly 200 is in the fully open position. By contrast, for front display dishwasher appliances, the illumination direction 222 may extend out a front end 206 door assembly 200 (e.g., extending from front panel 218). It should be appreciated that the directional orientations provided herein are only intended to facilitate discussion of aspects of the present subject matter, e.g., to describe the relative positioning of various components of control panel 220. However, it should be appreciated that these directional orientations may vary depending on the construction of the door assembly while remaining within the scope of the present subject matter.

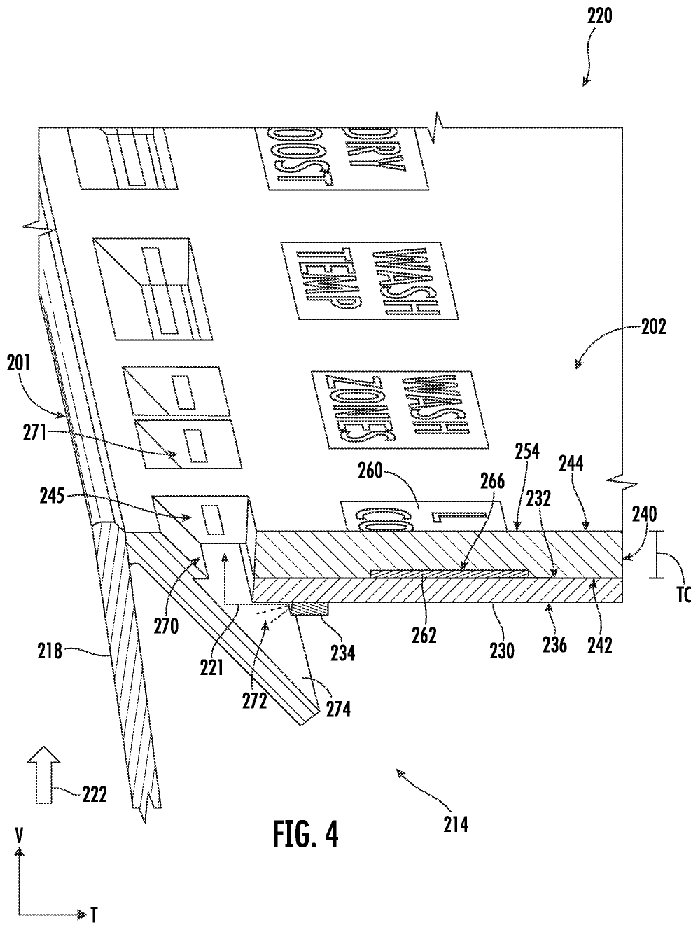

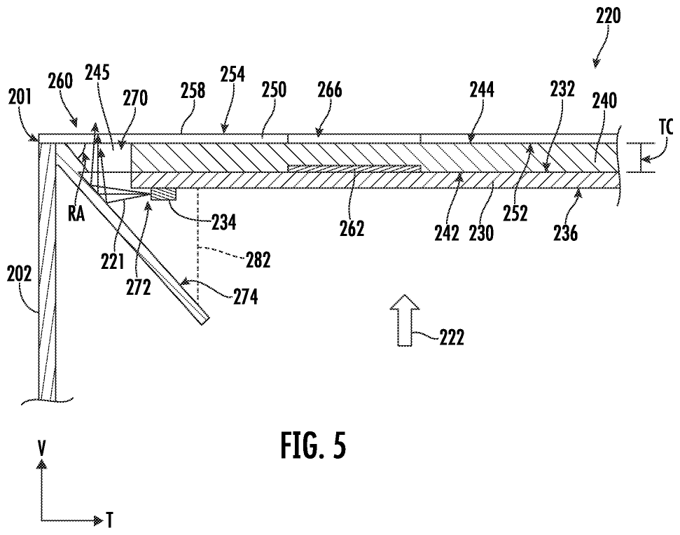

Referring now specifically to FIGS. 4 and 5, control panel 220 may generally include a user interface board or printed circuit board 230 that may generally be configured for supporting controller 160 and various other control inputs or outputs of dishwasher appliance 100. More specifically, as understood by one of ordinary skill in the art, printed circuit board 230 may include or be operably coupled to one or more user inputs (e.g., user inputs 166) for receiving user input and/or to one or more displays or indicators (e.g., display components 168) for providing user notifications, e.g., by illuminating indicators to indicate cycles or operating status.

According to the illustrated embodiment, printed circuit board 230 generally extends along a horizontal plane (e.g., along the lateral direction L and the transverse direction T) within door assembly 200. More specifically, printed circuit board 230 may extend along the lateral direction L within door assembly 200, e.g., at least partially between lateral ends 210. In addition, printed circuit board 230 may generally extend along the transverse direction T between front end 206 and rear end 208 of door assembly 200. According to the illustrated embodiment, printed circuit board 230 generally defines a top surface 232 that extends within a horizontal plane when door assembly 200 is in the closed position. Printed circuit board 230 further defines a bottom surface 236, and a top surface 232 located on an opposing surface from bottom surface 236. As shown, top surface 232 is located above bottom surface 236 in vertical direction V. Generally, top surface 232 is located proximate to an outer surface of door assembly 200 as compared to bottom surface 236.

According to the illustrated embodiment, door assembly 200 may further include a plurality of light sources 234 that are mounted to bottom surface 236 of printed circuit board 230 for selectively generating light. In this regard, light sources 234 may be configured for illuminating indicators, control inputs, or other features on control panel 220. These light sources 234 may include any suitable number, type, configuration, and orientation of light sources 234 mounted at any suitable location to illuminate status indicators or buttons in any suitable colors, sizes, patterns, etc.

In other words, light sources 234 may be provided as any suitable number, type, position, and configuration of electrical light source(s), using any suitable light technology, and illuminating in any suitable color. For example, according to the illustrated embodiment, light sources 234 may include one or more light emitting diodes (LEDs), which may each illuminate in a single color (e.g., white LEDs), or which may each illuminate in multiple colors (e.g., multi-color or RGB LEDs) depending on the control signal from controller 160.

However, it should be appreciated that according to alternative embodiments, light sources 234 may include any other suitable traditional light bulbs or sources, such as halogen bulbs, fluorescent bulbs, incandescent bulbs, glow bars, a fiber light source, etc. Moreover, light sources 234 may be operably coupled (e.g., electrically coupled) to printed circuit board 230, another suitable control board, and/or controller 160 (FIG. 2). Activation or illumination of light sources 234 may be generally controlled by a printed circuit board 230 or controller 160 (e.g., to indicate a user input, state of the dishwasher appliance, state of the wash cycle, or any other relevant information to a user).

According to exemplary embodiments, light sources 234 may include one or more orthogonally oriented light sources, referred to herein as side-fire light sources or light-emitting diodes (LEDs) (e.g., generating light 272 perpendicular to the illumination direction 222). In this regard, side-fire LEDs are generally configured for directing a beam of light energy substantially within a horizontal plane (e.g., as identified by the transverse direction T and/or the lateral direction L). For example, control panel 220 may include at least one side-fire LED mounted on printed circuit board 230 for generating light roughly perpendicular to illumination direction 222. In addition, or alternatively, light sources 234 may include one or more vertically light emitting devices, referred to herein as top-fire light sources or LEDs (e.g., generating light 272 parallel to the illumination direction 222). According to exemplary embodiments, In this regard, top-fire LEDs are generally configured for directing light primary along the vertical direction V when door assembly 200 is in the closed position. Light direction arrows 221 generally show light direction from light source 234 as it is redirected from light source 234 to illumination direction 222 through light channel 270, as will be described in more detail below.

As best shown in FIGS. 4 and 5, a control cover 240 is mounted to the top surface 232 of the printed circuit board 230. In this regard, for example, control cover 240 may be any suitable electrically insulated material that is mounted on top surface 232 of printed circuit board 230, e.g., to serve as a rigid support to facilitate user interaction with control panel 220. The control cover 240 may be opaque in some embodiments. Additionally or alternatively, control cover 240 may include a transparent or translucent material.

For example, according to the illustrated embodiment, control cover 240 may define a bottom cover surface 242 that is mounted in direct contact against top surface 232 of printed circuit board 230. In this regard, bottom cover surface 242 and top surface 232 may be substantially planar surfaces that extend along the horizontal direction when door assembly 200 is in the closed position.

According to alternative embodiments, printed circuit board 230 could also be mounted with adhesive between the top surface 232 of printed circuit board 230 and bottom cover surface 242 of control cover 240, may be spaced at a set distance, etc. In addition, control cover 240 may define a top cover surface 244 that is positioned opposite a bottom cover surface 242 along the illumination direction 222 (e.g., along the vertical direction V when door assembly 200 is in the closed position).

Control cover 240 generally extends parallel to top surface 232 of printed circuit board 230. For example, control cover 240 may extend in a plane with lateral direction L and transverse direction T when door assembly 200 is in the closed position. As shown, a portion 245 of control cover 240 extends beyond printed circuit board 230 in a direction parallel to the top surface 232 of printed circuit board 230. For example, control cover 240 extends in the lateral direction L and the transverse direction T beyond printed circuit board 230 when door assembly 200 is in the closed position. In the illustrated embodiment, control cover 240 may form an edge (e.g., front edge 201) with a first panel (e.g., front panel or outer door panel 218) of door assembly 200.

Control cover 240 may define at least one light channel 270, as shown in FIGS. 4 and 5. In some embodiments, control cover 240 may define at least two light channels 270, as shown in FIGS. 4 and 5. As shown in FIG. 5, control cover 240 may include a wall 282 extending between at least two light channels 270.

Light channel 270 may extend through control cover 240. As shown, light channel 270 may extend in vertical direction V when door assembly 200 is in the closed position. Generally, light channel 270 may extend substantially perpendicular to the directions control cover 240 or circuit board 230 extends in, light channel 270 extending from bottom cover surface 242 of control cover 240 to top cover surface 244 of control cover 240. Light channel 270 may be located on the portion 245 of control cover 240 that extends beyond circuit board 230 in the direction parallel to the top surface 232 of the circuit board 230. As shown, light channel 270 is located to a lateral side of circuit board 230. In some embodiments, light channel 270 is further located proximate to the edge formed with control cover 240 and an outer panel (e.g., front panel 218 of door assembly 200). For example, light channel 270 is located proximate to front edge 201 in FIGS. 4 and 5. Advantageously, this configuration of light sources 234 and light channels 270 may allow a light channel 270 to be closer to an edge (e.g., front edge 201) of door assembly 200 than was previously possible due to constraints of the printed circuit board 230 or spacing constraints at the edge of the door assembly 200. Though light channel 270 is shown proximate to front edge 201 in FIGS. 4 and 5, embodiments may include light channels 270 proximate to another edge, such as an edge formed with lateral ends 210 or inner door panel 216. Light channels 270 as described herein may allow for a greater closeness to edges of door assembly 200, beyond circuit board 230.

Light channel 270 as described herein may include a physical hole or aperture in control cover 240 or may be a translucent or transparent section of control cover 240. In other words, as used herein “channel” includes an aperture, or a portion 245 of a component that allows light to pass through it, such as a transparent section of control cover 240. In some embodiments, light channel 270 may expand, increasing in size between bottom cover surface 242 of control cover 240 and top cover surface 244 of control cover 240, as shown in FIG. 4. In some embodiments, light channel 270 may be a straight channel, having similar dimensions throughout.

As shown in FIGS. 4 and 5, control panel 220 further includes reflective surface 274. Reflective surface 274 may be attached to control cover 240. In some examples, reflective surface 274 may extend towards light source 234 from control cover 240. Reflective surface 274 may further be angled to direct light 272 selectively generated from light source 234 towards light channel 270. In some embodiments, reflective surface 274 may extend inward from an edge of control cover 240. As shown, reflective surface 274 extends inward from front edge 201 formed by control cover 240 and front panel 218 of door assembly 200.

It should be appreciated that light reflective surfaces 274 may be formed in any suitable manner. In this regard, light reflective surfaces may be any feature that is configured to redirect at least a portion of light 272. For example, reflective surfaces 274 may be molded walls attached to or molded with control cover 240 that define light directing channel 270.

In some embodiments, reflective surfaces 274 may include reflective films (not shown) that are deposited on control cover 240. In addition, the process of molding light directing channels 270 may leave a glossy finish that tends to reflect light, or a glossy finish may otherwise be imparted on the reflective surface 274 in any other suitable manner. Notably, according to exemplary embodiments, control panel 220 may generally have any suitable number, size, and configuration of reflective surfaces 274.

In some embodiments, control cover 240, and a reflective surface 274, may be a molded unitary piece. In other words, control cover 240 and reflective surface 274 may be a unitary piece molded from a single component, such as a plastic, metal, or silicone. In some embodiments, reflective surface 274 attached to control cover 240, reflective surface 274 being a separate piece of control panel 220. In some embodiments, reflective surface 274 may be directed towards control cover 240, and adjacent to control cover 240.

Further, in some embodiments, control cover 240 may have a thickness TC of less than 0.12 inches. In some embodiments, reflective surface 274 may also have a thickness less than 0.12 inches. In some embodiments, thickness TC of control cover 240 may be between 0.10 inches and 0.12 inches. Advantageously, having a molded, unitary control cover 240, including the reflective surface 274, may decrease the number of assembly procedures, decrease the number of parts, or generally simplify assembly process of control panel 220 or appliance 100.

Advantageously, given the thinness of control cover 240, the position of light source 234 on printed circuit board 230 may allow additional light reflectiveness than a light source (not shown) positioned on the top surface 232 of the printed circuit board 230, as the light source 234 on bottom surface 236 is a greater distance from a top cover surface 244 of control cover 240 than a light source positioned on top surface 232 of circuit board 230. The path of light 221 may also be greater given the path includes bouncing off of reflective surface 274 instead of being directed initially in illumination direction 222.

A reflective angle RA may be formed between control cover 240 and reflective surface 274. In other words, reflective surface 274 extends at reflective angle RA relative to cover plate. Reflective angle RA is not parallel or perpendicular to illumination direction 222. As shown, reflective angle RA is between the reflective surface 274 and bottom cover surface 242 of control cover 240. In some embodiments, reflective angle RA is less than 90 degrees. In this manner, light 272 does not tend to be redirected back towards light source 234. It should be appreciated that angle RA may vary while remaining within the scope of the present subject matter.

For example, according to exemplary embodiments, angle RA may be between about 5° and 80°. In some embodiments, angle RA may be between about 10° and 60°. In some embodiments, angle RA may be between about 30° and about 60°. In some embodiments, angle RA may be about 45°.

Generally, reflective angle RA allows light selectively produced from light source 234 to bounce off of reflective surface 274 and up through light channel 270, where a user may view the light shining from the light channel 270. In this regard, reflective surface 274 may be flat, curved, or otherwise shaped to provide the desired amount of light through light channel 270, depending on the needs of different embodiments.

In some embodiments, reflective surface 274 is further enhanced with a reflective coating or property. For example, reflective surface 274 may include a glossy, metallic, foiled, or pale colored covering, the covering directed towards the light source 234. This colored covering or inherent property of reflective surface 274 may aid in bouncing light off of reflective surface 274 and into light channel 270.

In embodiments with more than one light channel 270, and as shown in FIG. 5, a wall 282 may extend between light channels. For example, wall 282 may extend between light channel 270 and 271, light channel 270, and wall 282 shown in FIG. 5. Generally, wall 282 extends between the bottom cover surface 242 of control cover 240 and reflective surface 274. Wall 282 may block light from light source 234 to at least one of the at least two light channels. For example, light from light source 234 may be blocked from entering light channel 271 by wall 282. A second light source 234 (not shown) may similarly be blocked by wall 282 from entering light channel 270. Wall 282 may generally be placed between light sources 234, if more than one light source 234 is attached to printed circuit board 230. Wall 282 may be an opaque material, to allow light to pass through only the desired light channels 270.

In some embodiments, an overlay panel 250 may be mounted on top of control cover 240. Overlay panel 250 may be deposited on control cover 240. More specifically, overlay panel 250 may include a bottom overlay surface 252 that is seated directly against top cover surface 244 of control cover 240. In addition, overlay panel 250 may include a top overlay surface 254 that is directly interacted with by a user of dishwasher appliance 100. In general, overlay panel 250 may be any suitable panel for dead fronting control panel 220 to a user of dishwasher appliance 100. As used herein, the term “dead front” and the like is generally intended to refer to portions of a control panel which may be used as indicators, buttons, interactive control surfaces, or other user-interaction features without exposing the user to the operating side of the equipment or live parts and connections, i.e., lights, electrical connections, etc. According to exemplary embodiments, overlay panel 250 may further include a diffusion layer that is printed or applied to bottom overlay surface 252 of overlay panel 250 to help facilitate distribution of light 272.

For example, overlay panel 250 may be a transparent or translucent body and an opaque masking material or opaque film 258 that is selectively printed over top cover surface 244 of control cover 240 to define one or more indicator zones 260 (e.g., corresponding to user inputs 166 or other indicators) and/or other illuminated features on control panel 220. For example, the one or more diffused indicator zones 260 may include a translucent or transparent area of overlay panel 250, diffused indicator zones 260 allowing some light to pass through the one or more diffused indicator zones 260. In this regard, an opaque masking material 258 may be deposited on control cover 240, may be applied using an adhesive, or may be applied in any other manner to define any suitable number, size, and configuration of illuminated features. These illuminated features may be shapes or include other forms such as symbols, words, rectangle light indicators, etc. that are visible on control panel 220. More specifically, when light sources 234 are energized, diffused indicator zones 260 that correspond to the user inputs 166, or other indicators may be illuminated. Thus, the dead fronted top overlay surface 254 may be the surfaces that are contacted for controlling dishwasher appliance 100 or which may be illuminated for purposes of indicating operating status or other conditions to the user of the dishwasher appliance 100.

According to an exemplary embodiment, indicator zones 260 may correspond to user input buttons, such as first button 266. First button 266 may be positioned adjacent the indicators defined on control cover 240. As shown, first button 266 may be aligned with a capacitive sensor 262 and may be adjacent indicator zone 260. As shown, first button may be associated with light source 235, light channel 270 being adjacent to first button 266 in comparison to illumination direction 222. Light source 234 may be turned on or off with user inputs to first button 266. In additional or alternative embodiments, first button 266 is associated with a diffused indicator zone (not shown), light channel 270 aligned along the illumination direction with first button 266. First button 266 may be connected to printed control board 230. In this regard, first button 266, connected to control panel 162, may include at least one capacitive sensor 262 which is mounted to printed circuit board 230. In this manner, first button 266 may be a capacitive touch button 266. The at least one capacitive sensor 262 is also mounted below selected indicator zones 260 and is operable to detect user inputs on overlay panel 250 of control panel 220. For example, a capacitive sensor 262 may be mounted to printed circuit board 230 and may be configured for triggering when a user touches a top overlay surface 254 of overlay panel 250 proximate the capacitive sensor 262. In other words, the at least one capacitive sensor 262 may be operable to detect user inputs via contact with overlay panel 250. In particular, capacitive sensors 262 can detect when a finger or another conductive material with a dielectric different than air contacts or approaches control panel 220.

When a user touches top overlay surface 254 of overlay panel 250 adjacent one of capacitive sensors 262, such capacitive sensor 262 triggers and, e.g., signals a controller (e.g., controller 160). In such a manner, operations of dishwasher appliance 100 can be initiated and controlled. Capacitive sensors 262 may be distributed laterally on printed circuit board 230 below overlay panel 250. It will be understood that other any suitable number, type, and position of capacitive sensors 262 may be used while remaining within the scope of the present subject matter. Indeed, any suitable number, type, and configuration of touch buttons 266 or user inputs 166 may be used while remaining within the scope of the present subject matter.

In general, control cover 240 and/or overlay panel 250 may be constructed from any suitably rigid material to facilitate operation of dishwasher appliance 100. For example, it should be appreciated that various features of control panel 220 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, portions of control panel 220 may be formed from any other suitable rigid material.

As explained above, aspects of the present subject matter may generally be directed to a way to increase the distance of the LED or light source 234 to the overlay panel 250 using side-fire LEDs on the back of the printed circuit board 230 with reflecting surfaces of the control cover. Embodiments of this system may allow for larger diffused indicator zones 260 for improved appearance, as well as indicator zones 260 or light channels 270 with light sources 234 on the front surface of the board that can be positioned closer to the visual circuit board 230 space than previously possible. The system may use a side-fire LED to reflect parallel to the circuit board 230, down and around an edge, against the molded control cover 240 to both lengthen the distance between the light source 234 and the indicator zone 260 or the light channel 270 thus improving diffusion, as well as enabling the indicator zone 260 to be beyond the edges of the circuit board 230. This may help in reducing light source count and light sources 234 may be placed remotely to the indicator zone 260 or light channel 270 reducing board size and improving layouts.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A control panel for an appliance, the control panel defining an illumination direction and comprising:
a printed circuit board defining a top surface and a bottom surface, the top surface located on an opposing surface from the bottom surface;
a light source mounted to the bottom surface of the printed circuit board for selectively generating light;
a control cover mounted to the top surface of the printed circuit board, the control cover defining a light channel; and
a reflective surface extending towards the light source from the control cover, the reflective surface angled to direct light selectively generated from the light source towards the light channel.

2. The control panel of claim 1, wherein the control cover extends beyond the printed circuit board in a direction parallel to the top surface of the printed circuit board, and
wherein the light channel is located on a portion of the control cover that extends beyond the printed circuit board in the direction parallel to the top surface of the printed circuit board.

3. The control panel of claim 2, wherein the control panel is adjacent to an outer panel, the control cover forming an edge with the outer panel, and
wherein the light channel is proximate to the edge.

4. The control panel of claim 1, wherein the reflective surface extends at a reflective angle relative to the control cover, the reflective surface not being parallel or perpendicular to the illumination direction, and
wherein the reflective angle is measured between the reflective surface and a bottom cover surface of the control cover.

5. The control panel of claim 4, wherein the reflective angle is between about 30 degrees and 60 degrees.

6. The control panel of claim 4, wherein the reflective angle is about 45 degrees.

7. The control panel of claim 1, wherein the control cover is a molded control cover.

8. The control panel of claim 1, the control cover further defining at least two light channels, and
wherein a wall extends in between a bottom cover surface of the control cover and the reflective surface, blocking light from the light source to at least one of the at least two light channels.

9. The control panel of claim 1, further comprising an overlay panel deposited on the control cover, the overlay panel comprising one or more diffused indicator zones.

10. The control panel of claim 9, the overlay panel comprising an opaque film covering the control cover, the one or more diffused indicator zones comprising a translucent or transparent area of the overlay panel, the diffused indicator zones allowing some light to pass through the one or more diffused indicator zones.

11. The control panel of claim 9, further comprising a first button associated with the light source, the light channel adjacent to the first button.

12. The control panel of claim 11 wherein the first button comprises a capacitive sensor mounted to the printed circuit board, the capacitive sensor being operable to detect user inputs via contact with the overlay panel.

13. The control panel of claim 12, wherein the control cover comprises a transparent or translucent material.

14. The control panel of claim 1, wherein the reflective surface includes a glossy, metallic, or pale colored covering, the covering directed towards the light source.

15. The control panel of claim 1, wherein the light source comprises a side-fire light-emitting diode mounted on the printed circuit board for generating the light perpendicular to the illumination direction.

16. The control panel of claim 1, wherein a thickness of the control cover is less than 0.12 inches.

17. The control panel of claim 1, wherein the control panel is mounted on one of: a front panel of a door of a dishwasher appliance, a cutout portion of the front panel of the door of the dishwasher appliance, or a top panel of the door of the dishwasher appliance.

18. A dishwasher appliance with a lateral direction, a vertical direction, and a transverse direction the dishwasher appliance comprising:
a cabinet;
a door pivotably mounted to the cabinet and having a closed position;
a control panel located on a panel of the door, the control panel defining an illumination direction and comprising:
a printed circuit board defining a top surface and a bottom surface, the top surface located on an opposing surface from the bottom surface;
a light source mounted to the bottom surface of the printed circuit board for selectively generating light; and
a control cover mounted to the top surface of the printed circuit board, extending parallel to the top surface of the printed circuit board, the control cover defining a light channel and comprising a reflective surface extending towards the light source from the control cover, the reflective surface angled to direct light selectively generated from the light source towards the light channel.

19. The dishwasher appliance of claim 18, wherein the control cover extends beyond the printed circuit board in a direction parallel to the top surface of the printed circuit board, and
wherein the light channel is located on a portion of the control cover that extends beyond the printed circuit board in the direction parallel to the top surface of the printed circuit board.

20. The dishwasher appliance of claim 18, wherein the control panel is adjacent to an outer panel of the door, the control cover forming an edge with the outer panel, and
wherein the light channel is proximate to the edge of the door.
